(19) United States
(12) Patent Application Publication
(10) Pub. No.: US 2004/0237076 A1
(43) Pub. Date: Nov. 25, 2004

(54) Code out-lining

(76) Inventors: Geetha Vedaraman, Fremont, CA (US); Gerolf F. Hoflehner, Santa Clara, CA (US)

Correspondence Address: FISH & RICHARDSON, PC, 12390 EL CAMINO REAL, SAN DIEGO, CA, 92130-2081, US

(21) Appl. No.: 10/441,493

(22) Filed: May 19, 2003

(51) Int. Cl. G06F 9/45

(52) U.S. Cl. 717/160; 717/161; 712/216

(57) ABSTRACT

A method of compiling an executable program from a source code file, the method includes partitioning the source code file into code regions, determining register usage of at least two instructions in a first code region, and out-lining a first of the at least two instructions to be compiled as an executable instruction.

### BACKGROUND

A compiler program is generally used to convert a source code file written in a programming language (e.g., COBOL, C, C++, etc.) into an executable program, i.e., a set of machine language instructions that are executable by a computer processor. The format of the machine language instructions included in the executable program may be specific to the architecture of the computer processor that will be used to execute the program.

A computer processor may include one or more dynamic stacked registers (DSRs). A DSR refers to a register whose contents may be written to memory (“spilled” to memory) and read from memory (“filled” from memory) during execution of an executable program.

### DESCRIPTION OF THE DRAWINGS

FIG. 1 is a flowchart of a compilation process.

FIG. 2 is a block diagram of computer hardware on which the process of FIG. 1 may be implemented.

### DESCRIPTION

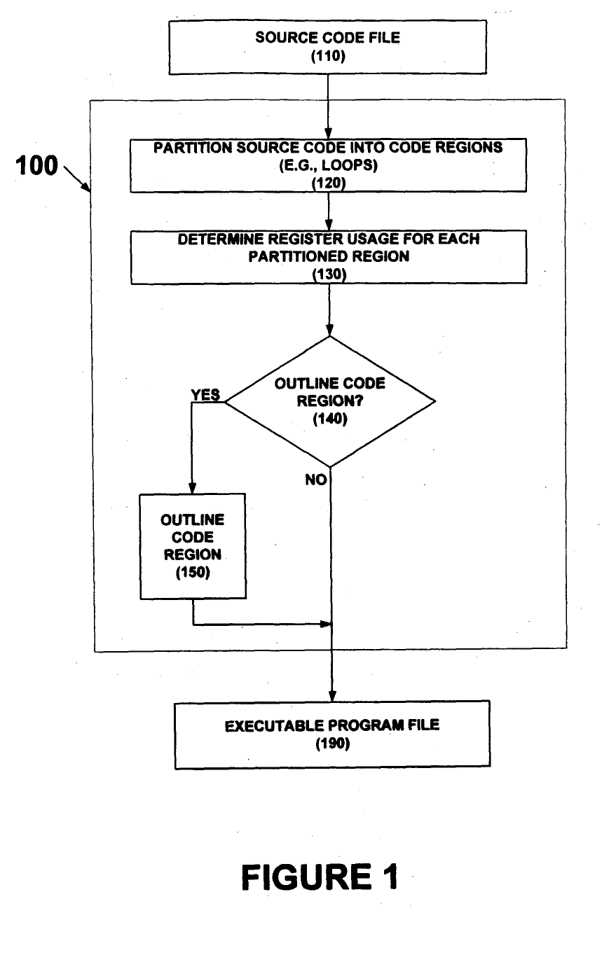

Referring to FIG. 1, a compilation process 100 is used to compile an executable program 190 from a source code file 110. Compilation process 100 includes actions (120, 130, 140 and 150) that may be used to “out-line” an instruction (a “candidate” instruction) included in a source code file to reduce competing accesses to DSRs during execution of executable program 190. In one implementation, out-lining refers to removing the candidate instruction from a first section of code (“a parent” code section) and replacing the instruction as a separate instruction(s) outside of the first section of code. As an example, performance of compilation process 100 may be advantageous where the parent code section includes a repetitive loop and both the parent code section and the candidate instruction(s) access DSRs. Therefore, out-lining the candidate instruction(s) as a separate instruction ensures that DSRs accessed by the parent code section will be spilled and filled only one time during execution of the separate instruction(s) rather than for each iteration of the parent code section.

A processor typically includes only a finite number of DSRs, as an example, the processor may include only ninety-six DSRs. Therefore, the processor may need to spill and fill DSRs whenever a total of more than ninety-six DSRs used by a first section of code are needed by a second section of code. Performance of compilation process 100, and out-lining of code sections that access DSRs, may reduce the amount of memory accesses during execution of program 190 on a processor that includes a finite number of DSRs. Moreover, the number of cycles necessary to issue memory accesses will increase as the number of memory ports for loading and storing data is reduced. Performance of compilation process 100, and out-lining of code sections that access DSRs, may reduce the amount of memory access-related cycles during execution of program 190.

Still referring to FIG. 1, process 100 includes partitioning (120) a source code file 110 into code regions, determining (130) DSR usage for each partitioned code region, determining (140) whether to out-line a candidate instruction included in the partitioned code region based on the determined DSR usage of the partitioned code region, and if it is determined to out-line the instruction, out-lining (150) the candidate instruction to be included in the executable source program 190.

Partitioning (120) may be implemented based upon an algorithm. For example, partitioning (120) may be based upon an algorithm that determines instruction(s) that may cause a single-entry and/or a single-exit into and out of a code region, for example, using an algorithm as described in “The Program Structure Tree: Computing Control Regions In Linear Time”, by R. Johnson, D. Pearson, and K. Pingali, PLDI 1994. The algorithm for partitioning (120) may also include determining code regions that include instruction(s) that cause multiple entries and/or multiple exits into and out of a code region, respectively.

Determining (130) register usage for each partitioned code region may be implemented using a register allocation algorithm, e.g., as described in “Register Allocation & Spilling Via Graph Coloring”, by G. J. Chaitin, ACM Symposium on Compiler Construction, 1982. In some implementations, determining (130) register usage may include determining DSR usage based upon a symbol table associated with the source code file, or based upon a call graph associated with the source code file.

Determining (140) whether to out-line a candidate instruction included in a partitioned code region (a “parent” code region) may be based on one or more rules that compare DSR usage of the parent code region to DSR usage of a candidate instruction(s) included within the parent code region. For example, a first rule may include determining whether a number of DSRs required by a parent code region plus a number of DSRs required by a function called from within the parent code region exceeds a total number of DSRs available on a processor. In more detail, the first rule may be represented by the equation:

(M+sF>N) Rule 1:

Where “sF” represents the number of DSRs required by the parent code region, “M” represents the number of DSRs required by the called function (the “callee”), and “N” represents a total number of DSRs available on a processor. In this example, the candidate instruction(s) is the call to the “callee” function.

A second rule for determining (140) whether to out-line a candidate instruction may include determining to out-line a candidate instruction only if the number of DSRs required by the candidate instruction(s) is less than both the number of DSRs required by the parent code region (“sF”) and also less than the number of DSRs required by the callee (“M”). If “sR” represents the number of DSRs required by the candidate instruction(s), the second rule may be represented by the equation:

(Min(sF, M)>sR)). Rule 2:

In one implementation, determining (140) includes determining that both Rule 1 and Rule 2 are satisfied before a candidate instruction(s) is out-lined.

An “alloc var” instruction is an exemplary C language instruction that may be used to allocate DSRs, where “var” is a variable specifying a number of DSRs. An alloc var instruction may be included within a variety of C language code sections, for example, an alloc var instruction may be included with a procedure code section, a function code section, etc.

Presented below is an exemplary source code section, Example 1. In this example it is assumed the processor has only ninety-six DSRs available. Example 1 includes a parent code region (lines 1-6) that includes a first procedure, “proc A” that allocates “regA” DSRs (line 2). Example 1 also includes a callee function “proc B” (lines 6-9) that allocates “regB” DSRs (line 8). The parent code region includes a loop (lines 3-5) that includes a call (line 4) to the callee function. Therefore, in Example 1, the candidate instructions include the loop of instructions (lines 3-5). In example 1, if the number of DSRs allocated by regA and regB are relatively large with respect to the available number of DSRs on the processor, every call to proc B (line 4) will cause (regA+regB−96) DSRs to be spilled, with a subsequent fill of (regA+regB−96) DSRs upon every return to proc A. This results in frequent spills and subsequent fills which may be unnecessary if the code required to setup proc B requires a relatively small number of DSRs.

EXAMPLE 1

| | |
|---|---|
| 1) | proc A(paramsA) { |

| | | |
|---|---|---|
| 2) | alloc regA; | // regA < 96 |

| | |
|---|---|
| | // A′s code section |
| 3) | for (i = 0; i < N; i++) { |

// Code setup of paramsB

| | |
|---|---|
| 4) | B(paramsB) ; |

| | |
|---|---|
| 5) | } |
| | // Some more code |

| | |
|---|---|
| 6) | } |
| 7) | proc B(paramsB) { |

| | | |
|---|---|---|
| 8) | alloc regB; | // regB < 96 |

| | |
|---|---|
| | // B′s code section. |
| 9) | } |

Example 2 (below) includes an out-lined code section that corresponds to the code shown in Example 1 (above). The code section shown in Example 2 may be produced by the performance of compilation process 100, discussed previously. The code section of Example 2 differs from Example 1 by out-lining the loop of instructions (lines 3-5 of Example 1) as a separate loop procedure, “proc LoopA” (lines 8-14 of Example 2). Therefore the call to “proc B” (line 4 of Example 1), which may cause repetitive spills and fills of a relatively large number of available DSRs, may be reduced by the out-lined code shown in Example 2, e.g., where only a single spill and fill of a relatively large number of DSRS is caused when “proc LoopA” (line 8 of Example 2) is called from “proc A” (line 5 of Example 2).

EXAMPLE 2

| | |
|---|---|
| 1) | proc A(paramsA) { |

| 2) | alloc regA; | // regA < 96 |
|---|---|---|
| 3) | // Some code | |
| 4) | // Setup of paramsLoopA = paramsB | |
| 5) | LoopA(paramsLoopA); | // Substitutes |
| | | loop |

| 6) | // Some more code | |
|---|---|---|
| 7) | } | |
| 8) | proc LoopA(paramsLoopA) { | |
| 9) | alloc regLoopA; | // regB < 96 |

| | |
|---|---|
| 10) | for (i = 0; i < N; i++) { |

| | |
|---|---|
| 11) | // Setup of paramsB |
| 12) | B(paramsB); |
| 13) | } |

| | |
|---|---|
| 14) | } |

| | |
|---|---|
| 15) | proc B(paramsP) { // Unchanged } |

Process 100 may be applicable to a source code including instructions that use a relatively large number of DSRs, and/or including code regions that include calls to other functions that require a relatively large number of DSRs.

Process 100 may also determine whether to out-line an instruction based on a comparison of other characteristics of a processor. For example, process 100 may use feedback data related to cache misses, branch prediction and register pressure in order to determine (140) whether to out-line a candidate instruction, for example.

Process 100 may be implemented as an executable application and executed on a computer system. As used herein, the term “computer system” refers to a physical machine having one or more processing elements and one or more storage elements in communication with the one or more of the processing elements. The various user devices and computers described herein typically include an operating system. The operating system is software that controls the computer system's operation and the allocation of resources. The term “process” or “program” refers to software, for example, an application program that may be executed on a computer system. The application program is the set of executable instructions that performs a task desired by the user, using computer resources made available through the operating system.

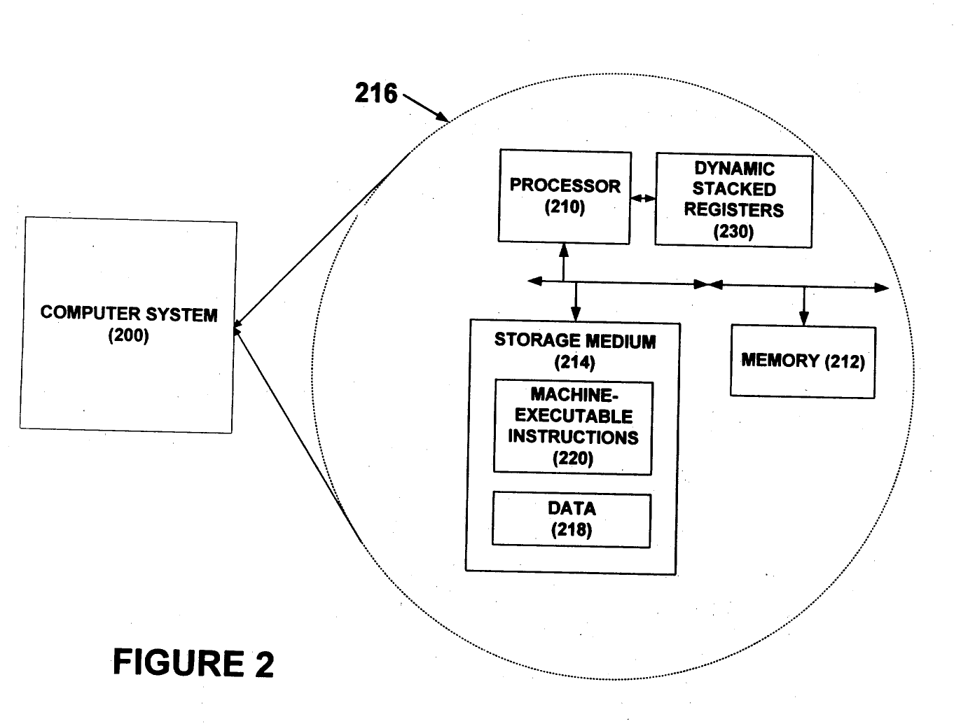

Referring to FIG. 2, an implementation of a computer system 200 includes a processor 210, a memory 212, a storage medium 214 and dynamic stacked registers 230 (see view 216). Storage medium 214 stores data 218 and also stores machine-executable instructions 220 that are executed by processor 210 out of memory 212 to perform functions (for example, process 100). Processor 210 may also execute instructions 220 to cause data to be stored in, or read from, one or more of the dynamic stacked registers 230.

Computer systems that may be used to implement the techniques described here are not limited to the components shown in FIG. 2. It may find applicability in any computing or processing environment. These techniques may be implemented in hardware, software, or a combination of the two. They may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform applications and to generate output information.

Each computer program may be stored on a storage medium/article (e.g., CD-ROM, hard disk, or magnetic diskette) that is readable by a general or special purpose programmable computer for configuring and operating the computer when the storage medium or device is read by the computer to perform applications. The disclosed techniques also may be implemented as a machine-readable storage medium, configured with a computer program, where, upon execution, instructions in the computer program cause a machine to operate in accordance with those applications.

The system and/or processes described here, or certain aspects or portions thereof, may take the form of program code (e.g., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the system and/or processes described here. The system and/or processes described here may also be embodied in the form of program code that is transmitted over some transmission medium, such as over electrical wiring or cabling, through fiber optics, or via any other form of transmission (such as an electronic connection), wherein, when the program code is received and loaded into and executed by a machine, such as a computer, the machine becomes an apparatus for practicing the system and/or processes described here. When implemented on a general-purpose processor, the program code combines with the processor to provide a unique apparatus that operates analogously to specific logic circuits.

The invention is not limited to the specific embodiments described above. For example, we described one implementation that included partitioning (120) a source code file into code regions before determining (130) register usage. However, in another implementation, determining (130) register usage may be performed before partitioning (120).

Other embodiments not described herein are also within the scope of the following claims.

What is claimed is:

1. A method comprising:
partitioning a source code file into code regions;
determining register usage of at least two instructions in a first code region; and
out-lining a first of the at least two instructions to be compiled as an executable instruction.

2. The method of claim 1, wherein said out-lining comprises re-arranging an order of execution of the first instruction outside of the first code region.

3. The method of claim 1, wherein said determining further comprises:
determining that the first instruction is included within a loop of instructions, and wherein out-lining further comprises re-arranging the loop of instructions outside of the first code region.

4. The method of claim 1, wherein said determining further comprises:
determining that the first instruction when executed will cause an access to a first number of registers; and
determining that the second instruction when executed will access a second number of registers that when combined with the first number of registers will exceed a number of available registers of a processing system.

5. The method of claim 1, wherein said determining further comprising:
determining that the first instruction includes a call to a second code region; and
determining that the second code region when executed will cause an access to the first number of registers.

6. The method of claim 5, further comprises:
determining that the number of registers required by the first instruction is less than the number of registers required by the first code region and less than the number of registers required by the second code region.

7. The method of claim 2, further comprises:
converting the out-lined instruction into a corresponding executable instruction.

8. The method of claim 2, wherein said partitioning comprises determining a code region based on an instruction that may cause at least one of an entry into the code region and an exit from a code region.

9. The method of claim 2, wherein said determining register usage comprises determining register usage based upon a symbol table associated with the source code file.

10. The method of claim 2, wherein said determining register usage comprises determining register usage based upon a call graph associated with the source code file.

11. An article comprising a machine-readable medium including machine-executable instructions operative to a cause a machine to:
partition a source code file into code regions;
determine register usage of at least two instructions in a first code region; and
out-line a first of the at least two instructions to be compiled as an executable instruction.

12. The article of claim 11, wherein out-lining comprises instructions that when executed by a processor results in the following:
re-arrange an order of execution of the first instruction outside of the first code region.

13. The article of claim 11, wherein determining further comprises instructions that when executed by a processor results in the following:
determine that the first instruction is included within a loop of instructions, and wherein out-lining further comprises re-arranging the loop of instructions outside of the first code region.

14. The article of claim 11, wherein determining further comprises instructions that when executed by a processor results in the following:
determine that the first instruction when executed will cause an access to a first number of registers; and
determine that the second instruction when executed will access a second number of registers that when combined with the first number of registers will exceed a number of available registers of a processing system.

15. The article of claim 11, wherein determining further comprising instructions that when executed by a processor results in the following:
determine that the first instruction includes a call to a second code region; and
determine that the second code region when executed will cause an access to the first number of registers.

16. The article of claim 15, further comprises instructions that when executed by a processor results in the following:
determine that the number of registers required by the first instruction is less than the number of registers required by the first code region and less than the number of registers required by the second code region.

17. The article of claim 12, further comprises instructions that when executed by a processor results in the following:
convert the out-lined instruction into a corresponding executable instruction.

18. The article of claim 12, wherein partitioning comprises instructions that when executed by a processor results in the following:
determine a code region based on an instruction that may cause at least one of an entry into the code region and an exit from a code region.

19. The article of claim 12, wherein determining register usage comprises instructions that when executed by a processor results in the following:
determine register usage based upon a symbol table associated with the source code file.

20. The article of claim 12, wherein determining register usage comprises instructions that when executed by a processor results in the following:
determine register usage based upon a call graph associated with the source code file.

21. A processing system for executing instructions, comprising:
a memory bus for accessing data;
a plurality of dynamic stacked registers; and
a module to execute a first instruction corresponding to an out-lined instruction, the instruction causing an access to one of the plurality of dynamically allocated registers without requiring a corresponding access to the memory bus.

22. The processing system of claim 21, wherein said module further comprises a module to execute a plurality of instructions corresponding to an out-lined loop of instructions, the plurality of instructions causing accesses to the plurality of dynamically stacked registers without requiring corresponding accesses to the memory bus.
